(19) United States
(12) Patent Application Publication
(10) Pub. No.: US 2011/0119256 A1
(43) Pub. Date: May 19, 2011

(54) INFORMATION PROCESSING APPARATUS, CONTROL METHOD THEREFOR, AND COMPUTER-READABLE STORAGE MEDIUM

(75) Inventor: Araki Matsuda, Kawasaki-shi (JP)

(73) Assignee: CANON KABUSHIKI KAISHA, Tokyo (JP)

(21) Appl. No.: 12/946,320

(22) Filed: Nov. 15, 2010

(30) Foreign Application Priority Data
Nov. 18, 2009 (JP) 2009-263078
Oct. 13, 2010 (JP) 2010-230647

(51) Int. Cl. G06F 17/30

(52) U.S. Cl. 707/722; 707/E17.014

(57) ABSTRACT

The present invention provides an information processing apparatus, in which an orientation is specified in response to a user's input operation, and average values of the latitude and the longitude in position information of a plurality of image files are obtained. A straight line in a specified orientation passing through a coordinate point showing the average coordinate values is used as a reference line. The image files, in which a distance between a coordinate point represented by position information of each image file and the reference line is smaller than a predetermined value, are sorted by latitude or longitude in the position information. As a result of the sorting, property information and reduced-size images of the image files are arranged and displayed on a display unit.

### BACKGROUND OF THE INVENTION

1. Field of the Invention

The present invention relates to an information processing apparatus configured to sort information according to positioning information and output the information, also relates to a control method for the same, and a computer-readable storage medium.

2. Description of the Related Art

It has become a general practice to use a personal computer which obtains image files from a photographic apparatus, and the image files are sorted according to attribute information (shooting time, file name, for example) and displayed on a display device.

Further, the photographic apparatus receives position information (such as latitude, longitude, altitude) from a GPS satellite, and adds this position information as attribute information indicating a shooting location to each image file.

Consequently, there arises a demand that image files should be sorted according to attribute information indicating a shooting location and results should be displayed on the display device. However, there is a problem that if image files are sorted merely according to any one of the latitude, longitude, and altitude in position information, its result often deviates from a user's intent and the user finds it difficult to obtain a desired image file.

### SUMMARY OF THE INVENTION

The present invention is directed to enabling the user to easily recognize information about image files and find out desired images by sorting image files by using attribute information indicating shooting locations according to the user's instruction, and displaying results on the display device.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating a structure of an information processing apparatus according to the present invention.

FIG. 2 is a flowchart illustrating operations to be performed in the information processing apparatus.

FIGS. 3A and 3B are diagrams illustrating examples of detailed screens.

FIG. 4 is a diagram illustrating a conformity calculation processing.

FIG. 5 is a diagram illustrating an example of a reduced-size image on the screen.

FIG. 6 is a diagram illustrating another example of a reduced-size image on the screen.

FIG. 7 is a flowchart illustrating operations to be performed on the information processing apparatus.

### DESCRIPTION OF THE EMBODIMENTS

Various exemplary embodiments, features, and aspects of the invention will be described in detail below with reference to the drawings.

The component parts described in the exemplary embodiments of the present invention are for the purpose of illustration only and are not intended to limit the scope of the present invention to those component parts.

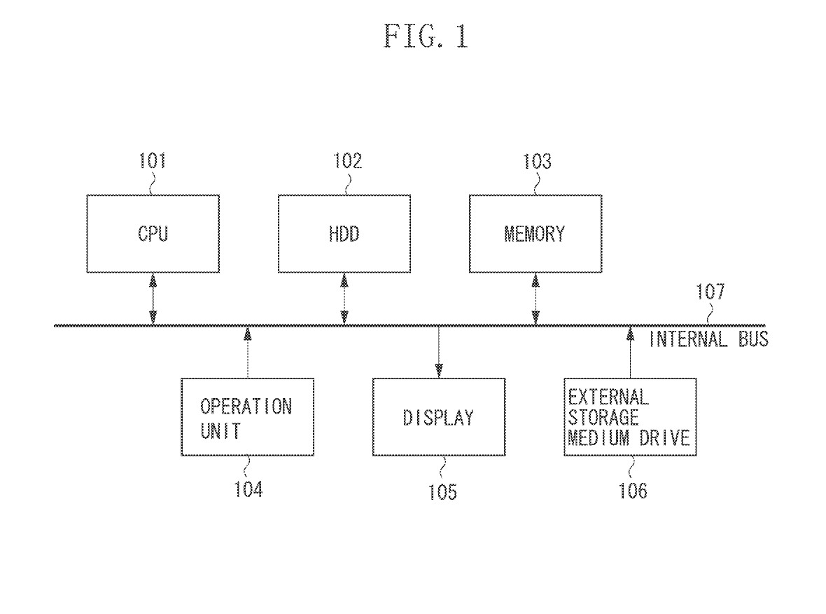

A structure of a computer apparatus which realizes an information output apparatus according to a first exemplary embodiment of the present invention will be described with reference to a block diagram in FIG. 1. The information output apparatus may be realized by a single computer apparatus, or by distributing respective functions to a plurality of computer apparatuses, as needed. When the information output apparatus is formed by a plurality of computer apparatuses, those computer apparatuses are connected via a local area network (LAN) to communicate with each other.

As illustrated in FIG. 1, an arithmetic processing apparatus 101 controls all of the operations of a computer apparatus 100, and an example of the arithmetic processing apparatus is a central processing unit (CPU). A hard disk drive mounted fixedly in the computer apparatus 100 stores execution programs, such as a sort program, which will be described below, and content data, such as coded image signals, in a readable form. The hard disk drive 102 also stores a plurality of image files obtained by a plurality of photographers using their photographic apparatuses.

A memory device 103 is a random access memory (RAM) or a read only memory (ROM), for example. An operating system (OS), program code, and content files recorded in the hard disk drive 102 are loaded in the memory device 103 and are executed by the arithmetic processing apparatus 101. A user's input operation on an operation unit 104 is detected by the arithmetic processing apparatus 101, and specified processing is performed according to the program code loaded in the memory device 103.

A display unit 105, which is formed by a CRT display, or a liquid crystal panel, displays images of an executed program and image files. An external storage medium drive 106 is used to read information stored in an external storage medium, such as a CD-ROM or a DVD-ROM. In the present exemplary embodiment, a program to be executed and a content file recorded in the hard disk drive 102 are read out. When they are recorded in an external storage medium, for example, they may be read via the external storage medium drive 106, and executed. Similarly, a program to be executed or a content file may be loaded into the memory device 103 via network, and executed. A system bus 107 communicably connects the units 101 to 106 with each other.

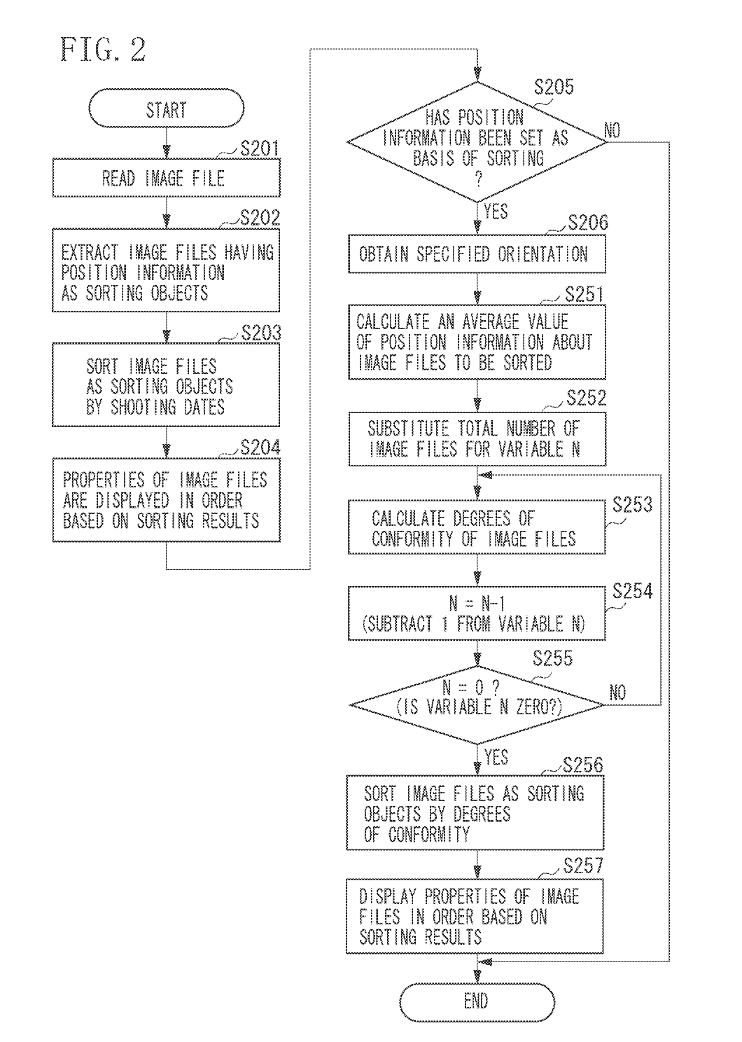

An operation of sorting image files according to its position information and a specified orientation will be described with reference to a flowchart in FIG. 2. The following operations can be performed when the arithmetic processing apparatus 10 of the information output apparatus reads an OS and a sort program from the hard disk drive 102 and executes the sorting program.

The arithmetic processing apparatus 101 reads image files from the hard disk drive 102 (step S201), and extracts image files each associated with the position information as sorting objects (step S202). The image files are generated when pictures are taken of objects by photographic apparatuses, and the position information represents the latitude and the longitude of a shooting location. The position information may be written in an image file or written in another file different from the image file and associated with the image file.

The image files extracted in step S202 are sorted according to shooting time and date (step S203), and property information of image files are arranged according to sorting results, and displayed on the display unit 105 (step S204).

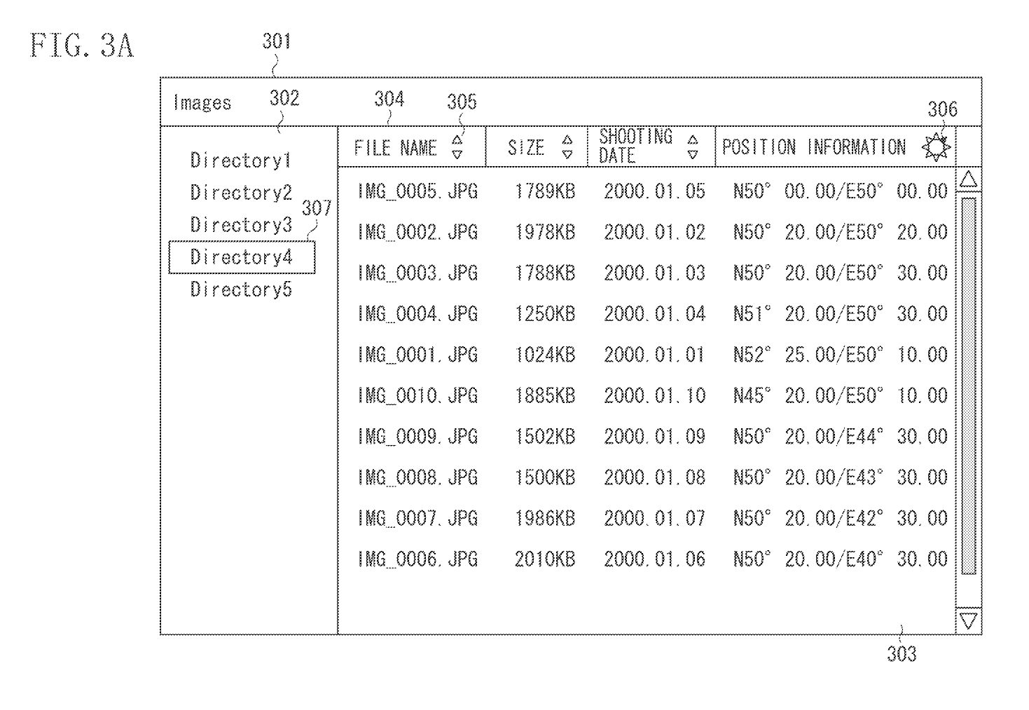

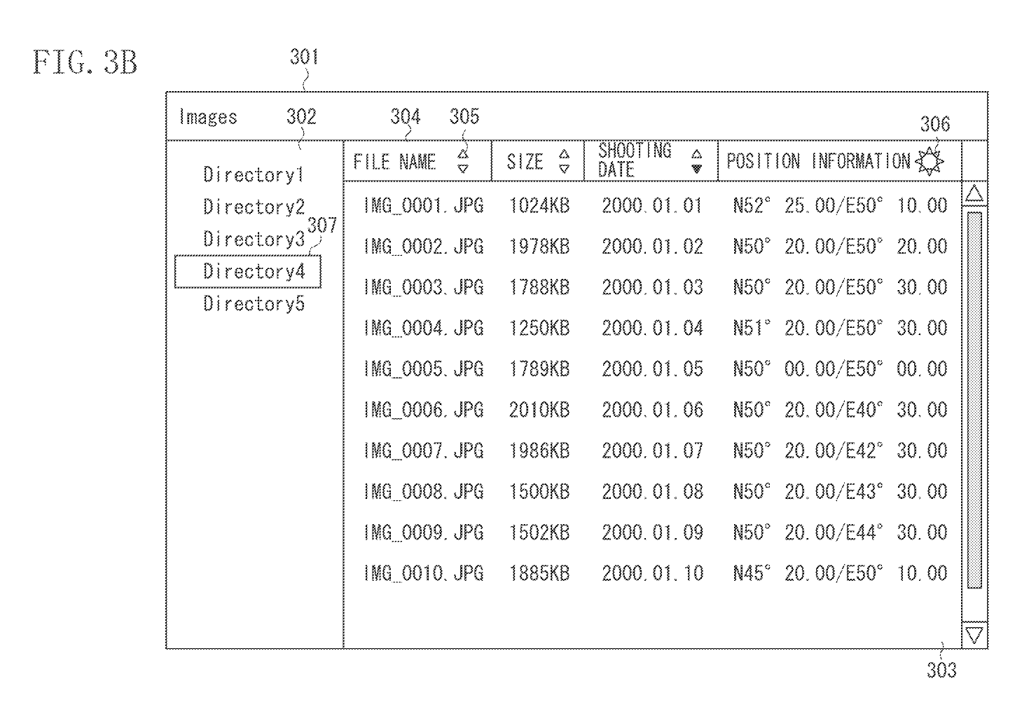

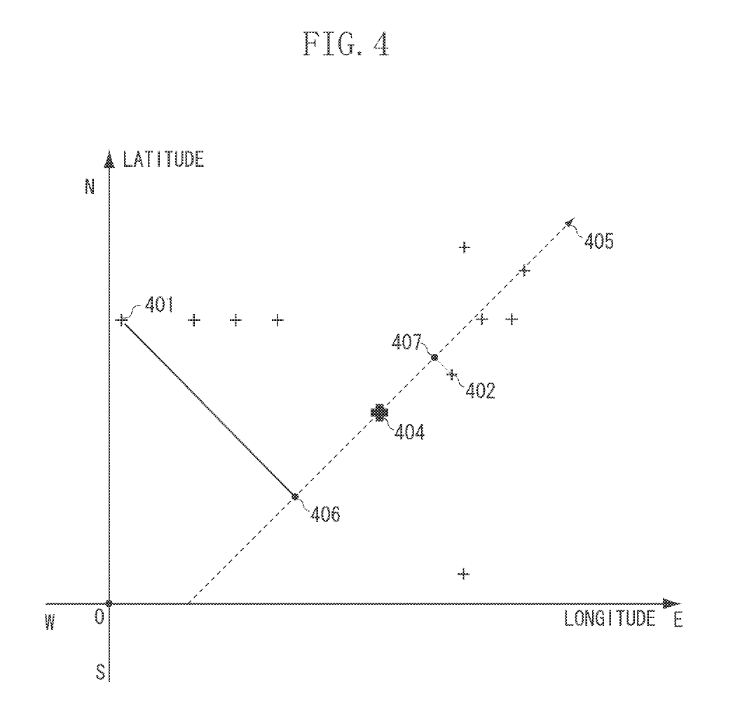

Detailed screens displayed in step S204 will be described with reference to FIG. 3B. The detailed screen 302 includes a directory selection area 302, a file list area 303, and a property item display area 304. The directory selection area 302 displays a list of directories to which the image files stored in the hard disk drive 102 of the information output apparatus belong. From this list, an image file belonging to a directory specified by the user's input operation is read in step S201. A selected directory is highlighted and a “directory 4” 307 is selected in FIG. 3B. In the file list area 303, property information of image files extracted in step S202 is displayed in list view. The property item display area 304 displays item names of property information shown in a list in the file list area 303. FIG. 3B illustrates file names, sizes, shooting dates, and position information. In FIG. 3B, the position information is represented by the latitude and the longitude in degree-minute notation. The property item display area 304 includes basis setting units 305, which the user can use to determine a basis for sorting information according to a property item of image files, and specify whether to sort image files in ascending order or in descending order. In FIG. 3B, the image files are sorted in descending order of shooting dates, and the basis setting unit 305 of the shooting date is highlighted.

Besides the basis setting units 305, there is a position information setting unit 306, which uses position information as a sorting basis, can select eight orientations. The orientations, up, down, left, and right, of the position information setting unit 306 correspond respectively to the orientations, north, south, east, and west. Furthermore, the orientations, the upper right, upper left, lower left, and lower right correspond to the orientations, north-east, north-west, south-east, and south-west. The orientations are not limited to eight, but may be increased or decreased.

The arithmetic processing apparatus 101 detects whether position information has been set as a basis for sorting image files, in other words, whether the user operates the position information setting unit 306 to specify an orientation as the basis for sorting image files (step S205). In step S205, if it is detected that the user operated the position information setting unit 306 (YES in step S205), a specified orientation is obtained (step S206). According to this exemplary embodiment, in this case, it is presumed that the user specifies the upper right on the position information setting unit 306, and in step S206, obtains the “north-east”.

The arithmetic processing apparatus 101 obtains the latitude and longitude values of each image file from position information associated with image files as sorting objects, and calculates their average values (in step S251), and substitutes a total number of image files to be sorted for an initial value of a variable N (step S252). The arithmetic processing apparatus 101 calculates degrees of conformity of image files based on the latitude and longitude values of image files and the average values (latitude and longitude) obtained in step S251 (step S253). The arithmetic processing apparatus 101 subtracts 1 from the variable N (step S254), and determines whether the variable N is “0” (step S255). If the variable N is determined not to be “0” in step S255 (NO in step S255), the arithmetic processing apparatus 101 performs the operations from step S253 onward for a next image file. When the variable N is determined to be “0”, in other words, when the calculation of conformity of all image files, which are to be sorted, is completed, the image files are classified and sorted according to calculated degrees of conformity (step S256). The arithmetic processing apparatus 101 arranges property information of image files according to sorting results, and displays the property information in the file list area 303 on the detailed screen 301 (step S257).

The calculation processing in step S253 will be described in detail with reference to FIG. 4. In FIG. 4, coordinate points 401 and 402 have a latitude value and a longitude value of position information, each of which is associated with one of image files as sorting objects. A coordinate point 404 has average values, calculated in step S251, of the latitude and the longitude of each image file as a sorting object. A reference line 405 passes through the coordinate point 404 with the average values (latitude and longitude), and indicates an orientation selected via the position information setting unit 306. In step S253, distances are calculated between the coordinates of the image files and points on the reference line at which perpendiculars from the coordinates of the image files intersect the reference line 405. It is determined that the shorter the calculated distance, the higher an image file's degree of conformity to a selected orientation becomes. For example, if coordinate points 401 and 402 are compared, the points on the reference line 405 at which the perpendiculars from the coordinate points 401 and 402 intersect the reference line 405 are coordinate points 406 and 407, and the distance from the coordinate point 402 to the coordinate point 407 is shorter. Therefore, so long as the two coordinate points 406 and 407 are concerned, it is determined that the image file corresponding to the coordinate point 402 has a higher degree of conformity to the orientation selected via the position information setting unit 306.

In this exemplary embodiment, when the distance from a coordinate point to the reference line is smaller than a predetermined value, an image file corresponding to the coordinate point is treated as a first sorting object, and the image files are sorted by longitude in ascending order. When the distance from a coordinate point to the reference line is larger than a predetermined value, an image file corresponding to the coordinate point is treated as a second sorting object, and the image files are sorted by distance from the reference line in ascending order. In step S256, a sorting result of the second sorting object is added to a sorting result of the first sorting objet. More specifically, the image file corresponding to a coordinate point with a highest degree of conformity takes a first place in a row and the image file corresponding to a coordinate point 401 with a second highest degree of conformity takes a second place in the row. Thus, the two image files are sorted by a degree of conformity in ascending order. However, the image files may be sorted in descending order instead of ascending order. The image file as the first sorting object may be sorted by latitude instead of longitude. Further, only the image file of the first sorting object may be extracted as a display object, and the image files are sorted by them.

The detailed screen displayed in step S257 will be described with reference to FIG. 3A. The detailed screen 301 displays the property information of the image files as sorting objects lined up in order of conformity as to a specified orientation.

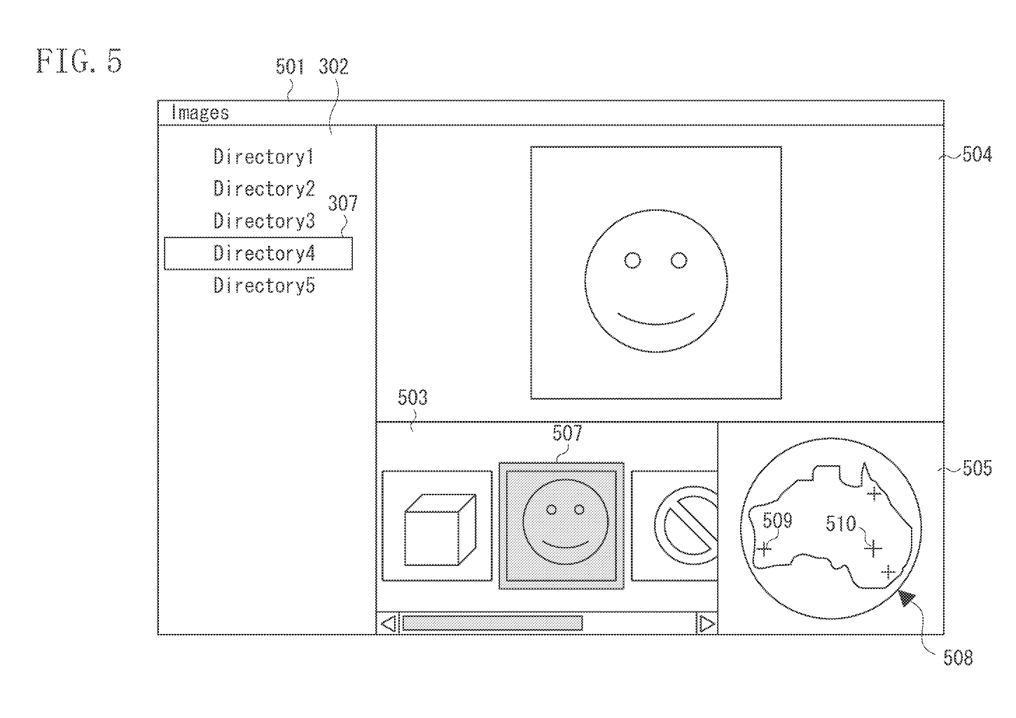

Further, instead of the detailed screen 301, a reduced image screen 501, illustrated in FIG. 5, may display reduced-size images of image files lined up in order of sorting results. A reduced image list view area 503 displays reduced images of the image files, lined up in order of sorting results when each of the image files have been determined to be associated with position information in step S202. A selected image area 504 displays an enlarged image of an image file corresponding to a reduced image selected from the reduced image list-view area 503. An orientation specifying controller 505 is operated by the user to specify a desired orientation as a basis for sorting by selecting a point along the periphery via the operation input unit 104. A mark 508 indicates a specified orientation. The orientation specifying controller 505 can display map information searched based on position information of image files as sorting objects on such a scale that position information of all sort target image files can be contained within the controller area.

A point 509 corresponding to the position information of an image file as a sorting object, and a point 510 corresponding to average values (latitude and longitude) of the position information of image files as sorting objects are displayed within the controller image. Location names of places on a map may be displayed. The coordinate point of an image file classified as a first sorting object in step S258 is highlighted by using a color different from the color of the coordinate points of other image files displayed on the orientation specifying controller.

According to the present exemplary embodiment, the user can view the sorted image files arranged along a desired orientation regardless of a shooting date and time, file name, file size, and model of the photographic apparatus. Therefore, by entering a shooting location, the user can easily recognize the image files existing in a specific orientation, and find out a desired image.

In a second exemplary embodiment, instead of an orientation, a route is specified as a basis for sorting. Descriptions similar to those in the first exemplary embodiment will not be repeated, but the structure particular to the second exemplary embodiment will be described in detail.

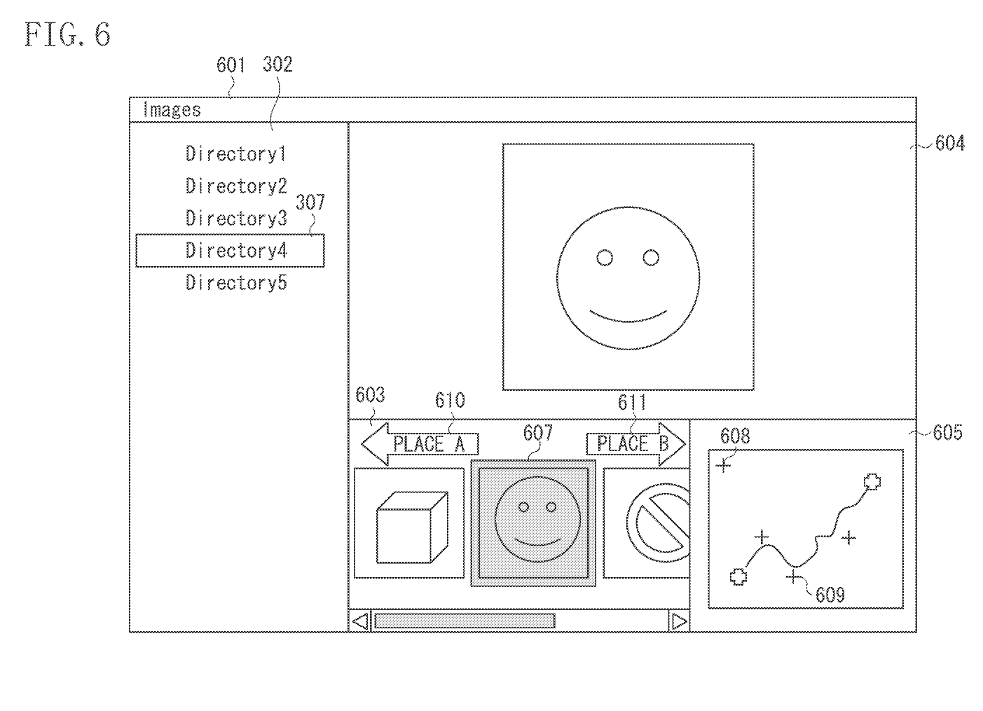

A reduced-size image screen in the second exemplary embodiment will be described with reference to FIG. 6. The reduced-size image screen 601 includes a route specifying controller 605. While operating the route specifying controller 605, the user sets a route from a start point to an end point by using the operation input unit 104. The route specifying controller 605 displays map information based on the position information of the image files as sorting objects on such a scale that the position information of all image files as sorting objects can be contained within the controller image. Points 608 and 609, which correspond to the position information of the image files as sorting objects, are displayed in the controller image. The reduced-size image list-view area 603 according to the second exemplary embodiment does not display a reduced image, among the sort image files when the distance from the image to the specified route is larger than a reference value. For example, location names of places 610 and 611 are displayed as information about the start point and the end point of a specified route. Since the hard disk drive 102 of the information output apparatus stores a list in which the place names are associated with their latitudes and the longitudes, by referring to this list, the arithmetic processing apparatus 101 obtains and displays the location names corresponding to the start point and the end point.

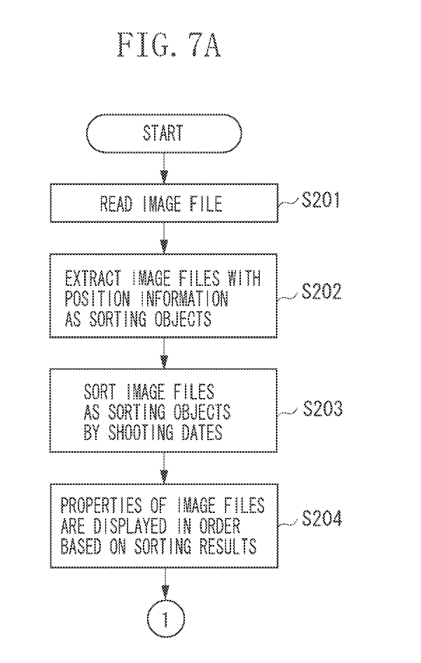

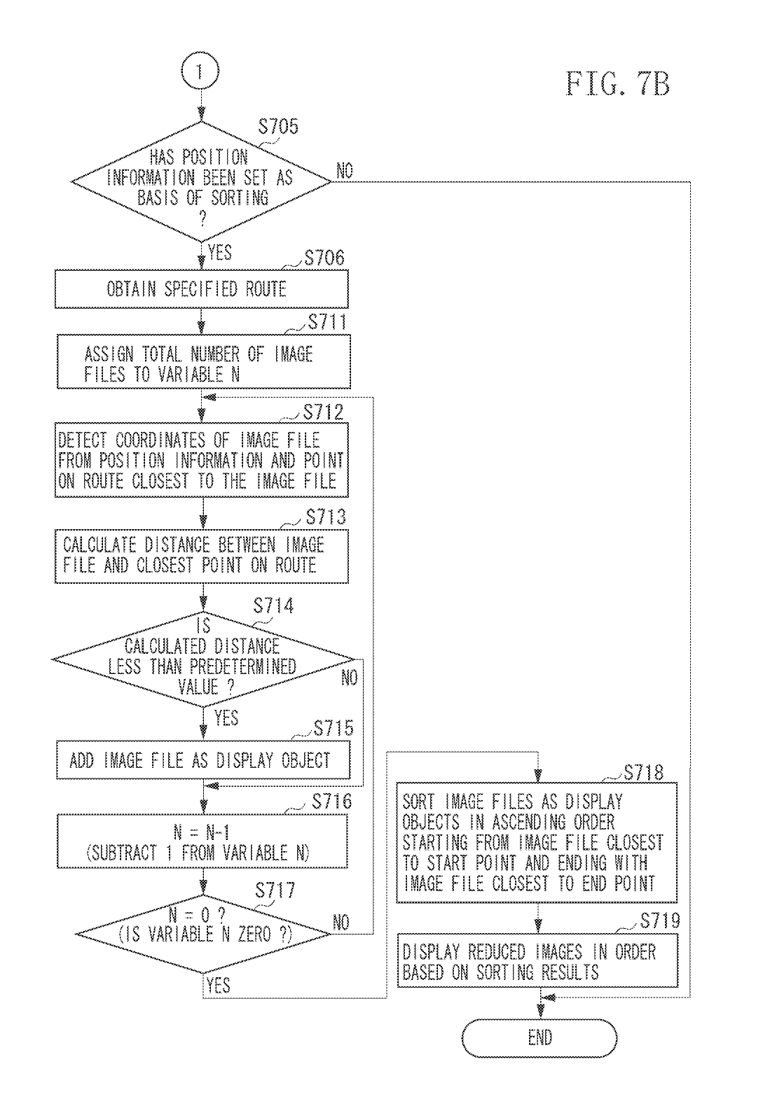

An operation of sorting the image files by position information and specified route in an information output apparatus will be described with reference to a flowchart in FIG. 7. The following operation is performed when the arithmetic processing apparatus 101 of the information output apparatus reads an OS and a sorting program from the hard disk drive 102, and executes the sorting program.

The arithmetic processing apparatus 101 determines whether position information has been set as the basis for sorting, in other words, whether the user has operated the route specifying controller to specify a route (step S705). If it is detected that the user has operated the route specifying controller 605 (YES in step S705), the arithmetic processing apparatus 101 obtains information about the specified route (step S706). In the second exemplary embodiment, it is presumed that the user specifies a route illustrated in FIG. 6. The arithmetic processing apparatus 101 substitutes a total number of sort target image files for an initial value of a variable N (step S711). The arithmetic processing apparatus 101 detects a coordinate point indicated by position information of an image file and a point on a route closest to the coordinate point (step S712), calculates a distance between those points (step S713), and determines whether the calculated distance is less than a predetermined value (step S714). In the second exemplary embodiment, the predetermined value is 100 meters. As a result of determination in step S714, if the calculated distance is less than the predetermined value (YES in step S714), the arithmetic processing apparatus 101 adds the image file as a display object (step S715). The arithmetic processing apparatus 101 subtracts 1 from the variable N (step S716), and determines whether the variable N is “0” (S717). If it is determined in step S717 that the variable N is not “0” (NO in step S717), the arithmetic processing apparatus 101 executes processing from step S712 on for the next image file. In step S717, if the variable N is “0” (YES in step S717), in other words, if the processing of all sort target image files has been completed, the image files as display objects are sorted in ascending order starting from an image file at the start point and ending at an image file at the end point of the route (step S718). Based on sorting results in step S718, the arithmetic processing apparatus 101 displays reduced images of image files as display objects lined up in a reduced image list-view area 603 (step S719). The coordinate point of an image file added as a display object in step S715 is highlighted, for example, in a color different from the color of the coordinate points of other image files on the route specifying controller 605.

In the second exemplary embodiment, the user can view sorted image files arranged along a desired route regardless of shooting date and time, file name, file size, and a model of the photographic apparatus, for example. Therefore, the user can easily recognize image files existing on a specific route and find out a desired image by entering a shooting location as a key word.

Cases where image files are used as sorting objects have been described in the first and second exemplary embodiments. However, the present invention can be applied to files of other contents each associated with position information.

### Another Exemplary Embodiment

The present invention can also be realized by performing processing as follows. Software (program) to execute the functions of the exemplary embodiments described above is supplied to a system or an apparatus via a network or by using various types of storage media, and a computer (or a CPU or a MPU) of the system or the apparatus reads and executes the program.

To execute the functions of the exemplary embodiments, in addition to executing program code read by the computer, it is also possible to cause an operating system (OS) running on the computer to execute a part of or all of an actual processing based on instructions of the program code and by this processing, the functions of the above-mentioned exemplary embodiments are realized. The functions of the exemplary embodiments can also be realized by a processing as follows. The program code read from a storage medium is written in the memory of a function extension board included in the computer or in a function extension unit connected to the computer. Then, in response to instructions of the program code, a part of or all of actual processing is performed by the CPU in the function extension board or the function extension unit. This case is also included in the scope of the present invention.

### Other Embodiments

Aspects of the present invention can also be realized by a computer of a system or apparatus (or devices such as a CPU or MPU) that reads out and executes a program recorded on a memory device to perform the functions of the above-described embodiment (s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-263078 filed Nov. 18, 2009, which is hereby incorporated by reference herein in its entirety.

What is claimed is:

1. An information processing apparatus for outputting information about an image file generated by taking an image of an object by a photographic apparatus, wherein each of the image files is associated with position information representing a shooting location, the apparatus comprising:
a specifying unit configured to specify an orientation;
a sorting unit configured to sort a plurality of image files by a specified orientation and by position information, wherein each of the image files is associated with the position information; and
a display unit configured to display information about the image files arranged according to sorting results.

2. An information processing apparatus for outputting information about an image file generated by taking an image of an object by a photographic apparatus, wherein the image file is associated with position information representing a shooting location, the apparatus comprising:
a calculation unit configured to calculate average values (latitude and longitude) of position information associated with a plurality of image files;
a specifying unit configured to specify an orientation;
a setting unit configured to set a reference line passing through a coordinate point of the average values and oriented in the specified orientation;
a computing unit configured to compute a distance between a coordinate point represented by position information of the image file and the reference line;
a sorting unit configured to sort the plurality of image files by longitude or latitude in the position information, wherein in each of the image files, the computed distance is smaller than a predetermined value; and
a display unit configured to display information about the image files, arranged based on the sorting results, on a display unit.

3. The information processing apparatus according to claim 2, wherein the display unit displays a coordinate point represented by position information of the image file on map information, and highlights points corresponding to the plurality of image files, in which the calculated distances are smaller than predetermined values.

4. An information processing apparatus for outputting information about an image file generated by taking an image of an object by a photographic apparatus, the image file being associated with position information representing a shooting location, comprising:
a specifying unit configured to specify a route;
a detection unit configured to detect a point on the route closest to position information associated with each of a plurality of image files;
a sorting unit configured to sort the plurality of image files, in which a distance from the coordinate point represented by the position information of each image file to the detected point on the route is smaller than a predetermined value, by the distance from an end point of the specified distance; and
a display unit configured to display information about the image files, arranged based on the sorting results, on the display unit.

5. The information processing apparatus according to claim 4, wherein the display unit displays points represented by position information of the image files on map information, and highlights the points corresponding to the plurality of image files, in which a distance from the coordinate point represented by the position information of each image file and the detected point on the route is smaller than the predetermined value.

6. A control method of an information processing apparatus for outputting information about an image file generated by taking an image of an object by a photographic apparatus, the image file being associated with position information representing a shooting location, the control method comprising:
specifying an orientation;
sorting a plurality of image files by a specified orientation and by position information, wherein each of the image files is associated with position information; and
displaying information about the image files, arranged according to sorting results.

7. A computer-readable storage medium storing a computer program for causing a computer, which realizes an information processing apparatus for outputting information about an image file generated by taking an image of an object by a photographic apparatus, wherein each of the image files is associated with position information representing a shooting location, to execute operations comprising:
specifying an orientation;
sorting a plurality of image files, in which each of the image files is associated with position information, by a specified orientation and position information; and
displaying information about the image files, arranged according to sorting results on a display unit.

8. A control method of an information output apparatus for outputting information about an image file generated by taking an image of an object by a photographic apparatus, wherein each of the image files is associated with position information representing a shooting location, the control method comprising:
calculating an average value of position information associated with a plurality of image files;
specifying an orientation;
setting a reference line passing through the average value point and oriented in the specified orientation;
computing a distance between a coordinate point represented by position information of the image file and the reference line;
sorting the plurality of image files, in which the computed distance is smaller than a predetermined value, by longitude or latitude in the position information; and
displaying information about the image files, arranged based on the sorting results, on a display unit.

9. A computer-readable storage medium storing a computer program for causing a computer, which realizes an information output apparatus for outputting information about an image file generated by taking an image of an object by a photographic apparatus, wherein each of the image files is associated with position information representing a shooting location, to execute operations comprising:
calculating average values (latitude and longitude) of position information associated with a plurality of image files;
specifying an orientation;
setting a reference line passing through the average value point and oriented in the specified orientation;
computing a distance between a coordinate point represented by position information of the image file and the reference line;
sorting the plurality of image files by longitude or latitude in the position information, wherein in each of the image files, the computed distance is smaller than a predetermined value; and
displaying information about the image files, arranged based on the sorting results, on a display unit.

10. A control method of an information output apparatus for outputting information about an image file generated by taking an image of an object by a photographic apparatus, wherein each of the image files is associated with position information representing a shooting location, the control method comprising:
specifying a route;
detecting a point on the route closest to position information associated with each of a plurality of image files;
sorting the plurality of image files by the distance from an end point of the specified distance, wherein in each of the image files, a distance from a coordinate point represented by the position information to the detected point on the route is smaller than a predetermined value; and
displaying information about the image files, arranged based on the sorting results, on a display unit.

11. A computer-readable storage medium storing a computer program for causing a computer, which realizes an information processing apparatus for outputting information about an image file generated by taking an image of an object by a photographic apparatus, wherein each of the image files is associated with position information representing a shooting location, to execute operations comprising:
specifying a route;
detecting a point on the route closest to position information associated with each of a plurality of image files;
sorting the plurality of image files by the distance from an end point of the specified distance, wherein in each of the image files, a distance from a coordinate point represented by the position information of each image file to the detected point on the route is smaller than a predetermined value; and
displaying information about the image files, arranged based on the sorting results, on a display unit.
